(19) United States
(12) Patent Application Publication
(10) Pub. No.: US 2008/0052396 A1
(43) Pub. Date: Feb. 28, 2008

(54) PROVIDING A SERVICE FROM AN APPLICATION SERVICE PROVIDER TO A CLIENT IN A COMMUNICATION SYSTEM

(75) Inventors: Daniel F. Tell, Lake Forest, IL (US); Mark A. Gannon, Sleepy Hollow, IL (US); Barry J. Menich, South Barrington, IL (US); Stephen L. Spear, Skokie, IL (US); Steven D. Upp, Bartlett, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/466,126

(22) Filed: Aug. 22, 2006

(51) Int. Cl. G06F 15/16; G06F 15/173

(52) U.S. Cl. 709/226; 709/238; 709/203

(57) ABSTRACT

A method and apparatus for providing a service from an application service provider to a client in a communications system including a network proxy describes a first step of defining services provided by the service provider as Extensible Markup Language (XML) metadata. A next step includes defining services desired by the client as XML metadata. A next step includes collecting the XML metadata from the client and service provider. A next step includes comparing the client XML metadata against the service provider XML metadata. A next step includes providing the substantially matched service from the service provider to the client upon the finding of a substantial match between the client metadata and the service provider metadata.

### FIELD OF THE INVENTION

This invention relates generally to communications systems and, in particular, to methods and apparatus for providing services to clients in a wireless communications system.

### BACKGROUND OF THE INVENTION

There is an ever increasing demand for wireless communications and services. Wireless subscribers desire to have access to wireless services at any time and at any place. The services can originate from multiple sources, such as the Internet and other public, private, and/or government computer-based networks; wireless telecommunications such as cellular, Personal Communication Service (PCS), satellite, land-mobile, and the like; terrestrial and satellite direct broadcasts including traditional AM/FM bands, broadband, television, video, geolocation and navigation via a global position system (GPS), and the like; concierge services providing roadside assistance, emergency calling, remote-door unlocking, accident reporting, travel conditions, vehicle security, stolen vehicle recovery, remote vehicle diagnostics, and the like; advertising services identifying names and locations of businesses such as gas stations, restaurants, hotels, stores, and offices, and the like; tourist services such as points of interest, directions, hours of access, and the like; and many other sources that can provide information of any type. Many of the above services are not universally available, but rather they are transient in both the time and location.

The services provided by the various communication systems can be provided to subscribers at home, at work, in a vehicle, or elsewhere. With so much mobility, the equipment located in the subscriber's vehicle, or the equipment carried by or otherwise serving a subscriber, needs a way to connect with the plethora of services that are potentially available to it. The equipment needs a way to discover, identify, select, and invoke services that are of interest to it, as well as to disconnect from services that are no longer of interest to it.

It is known in the art for applications residing on a client platform to individually locate any desired service. However, it can be an undesirable drain upon the applications, their platform, and the bandwidth available to the platform, for each application to independently interact with a desired service. Further, the need to interact differently with local or remote services requires additional complexity in the client platform and interaction with the client.

It is also known in the art for intermediate service brokers to search for Internet services and present these services to a client device. This mitigates the burden on client device processing to search for services. However, client interaction is greatly increased, and this interaction can be distracting to a client in that all types of unwanted services will be provided to the client for selection.

It is also known for the Internet's Really Simple Syndication (RSS) to provide dynamically changing content to user. RSS is used for distributing news to subscribers from news websites/weblogs, alerting subscribers about software bug reports, or podcasting new content. Typically the sites have content that changes routinely. RSS uses an “feed reader” or “aggregator”, so-called because it can combine all RSS feeds on a topic into a single feed to the user. This aggregator or “feed reader” is becoming more common as a feature in popular web browsers. However, RSS only deals with content and not services. As such, RSS looks for changes to existing content, but does not search for unrelated and previously unknown content, let alone new or previously unknown services or application.

In addition, services like RSS have no explicit knowledge of the user's equipment capabilities, nor his/her service interests.

Accordingly, there is a need for a method and apparatus that delivers only desired services from a service provider to a client device.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 depicts an exemplary communication system, according to the present invention;

FIG. 2 depicts a message diagram implemented for the communication system of FIG. 1;

FIG. 3 illustrates a flow diagram of a method of providing a service from an application service provider to a client in a communications system.

Skilled artisans will appreciate that common but well-understood elements that are useful or necessary in a commercially feasible embodiment are typically not depicted or described in order to facilitate a less obstructed view of these various embodiments of the present invention.

### DETAILED DESCRIPTION OF THE DRAWINGS

The present invention provides a method and apparatus for delivering only desired services from a service provider to a client device. The present invention provides for the advertising of services available in a network to devices or associated proxies, having an aggregator associated with each client that collects the advertisements for available services and filters them based on client preference, and then provides for subscription to the service if a match is determined. For example, an Internet network could provide services in accordance with the present invention.

In essence, when a new service is ready for release by a service provider, the service is placed on the network and the service provider advertises its service using XML notation. In each client device or in a network proxy for the client sits an aggregator, or reader. It receives the advertisement from the new service and compares it to a preference filter for the subscriber. If there is interest in the service, it is presented to the user for subscription. The user indicates such on the client device and, if affirmative, the aggregator provides an easy subscription to the service. Optionally, the subscription can be provided automatically without user interaction, if such is indicated in the user preferences.

Advantageously, the present invention provides a simple and accurate procedure to obtain only those services desired by a user with minimum effort. In particular, as soon as a service or application is loaded onto a network, all subscribers (client devices) are notified of its capacities and may elect to subscribe, dramatically improving feature velocity.

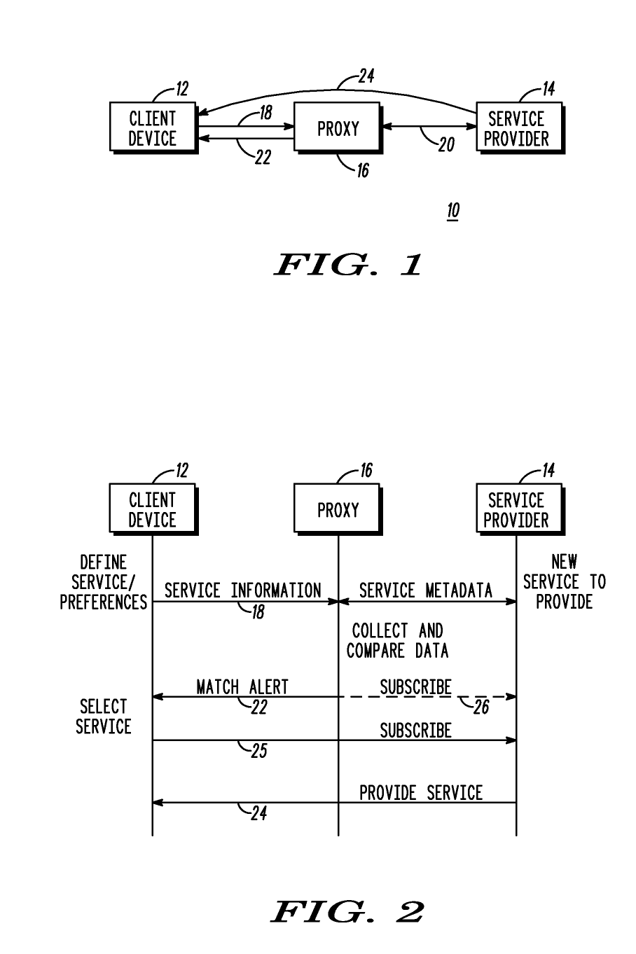

FIG. 1 depicts a communication system 10, in accordance with the present invention. A client device 12 without limitation can include a wireless unit such as a portable radiotelephone, mobile radiotelephone, cellular or Personal Communication Service (PCS) telephone, a pager, a hand-held computing device such as a personal digital assistant (PDA), computer, Web appliance, or any other type of communications and/or computing device that can transmit and receive information using wireless communications means. Without limitation, one or more client devices 12 can be contained within, and optionally form an integral part of a vehicle, such as an automobile, truck, bus, train, aircraft, or boat, or any type of structure, such as a house, office, school, commercial establishment, and the like. The client device 12 also comprises a user interface that can include without limitation a tactile interface, keypad, microphone, speakers, displays, and the like, for communicating a user's preferences to the network proxy 16 and/or service providers 14. The client device includes a transceiver for communication with other entities of the network, such as network proxy 16 and service provider 14, for example.

At least one service provider 14 is shown that is at least one network entity that provides various services and applications for use by client device 12, for example, as is known in the art. In one example, service providers 14 can be Internet web sites where particular services or applications can be downloaded to the client device 12 over an Internet carrier network that is able to offer end user services.

A network proxy 16 is associated with the client device 12. The network proxy includes an aggregator or reader to determine services or applications that are available from the various service providers 14 of the network. The network proxy 16 can be implemented within the client device 12 or can be a standalone system. In addition, a network proxy 16 can be coupled to any number of client devices 12, via wireline or wireless interface means. The network proxy 16 is also coupled to any number of and service providers 14, via wireline or wireless interface means. The network proxy 16 utilizes a processor with associated memory that can include, but is not limited to, random access memory (RAM), read only memory (ROM), flash memory, and other memory such as a hard disk, floppy disk, and/or other appropriate type of memory. The network proxy 16 can initiate and perform communications with service providers 14.

Service providers and network proxies, while illustrated as coupled to the client device, could be implemented at any hierarchical level(s) within the communication system 10. For example, the servers could also be implemented within one or more local or remote nodes of the network and Internet. Without limitation, the servers can be located in a kiosk, cell site, local area network (LAN), telephone company, cable company, satellite, or any other information service, structure, or entity that can transmit, receive, and/or communicate information. A “service” as defined herein can be any arrangement conveyed by the network to the user to provide information or to initiate some kind of activity or any desired service including, but not limited to, telecommunications, broadband communications, entertainment, television, radio, recorded music, movies, computer-based games, Internet, and other types of public, private, personal, commercial, government, and military communications. As used herein, an “application” is defined as any computer program that provides one or more functions that are of interest to a user of the communication system.

Referring to FIGS. 1 and 2, a client device 12 defines those services or applications of interest to a user. The information can also include service preferences or other preferences of the user, which can be used by the network proxy as a filter, as will be detailed below. In practice, the user enters information in the user interface of, or downloads information to, the client device specifying desired services or applications. Preferably, such information could be entered in natural language form. The entries could include a constrained number of predefined and agreed-upon keywords, which could be displayed as a table on a user interface of the client device, for example. These keywords can then be mapped into previously agreed-upon XML metadata that specifies attribute set objects that characterizes the service or application. The information is eventually passed 18 to the network proxy 16. The information is translated and encapsulated into Extensible Markup Language (XML) metadata. The translation can occur in processors of the client device 12, network proxy 16, or both. Alternatively, an ontology-based algorithm can be used to identify semantics of a client's desired service or preference, wherein a subsequent comparison with metadata includes a semantic similarity measurement.

In addition, the information may undergo intermediate translations. One possible intermediate translation path is a conversion from natural language to a Subject Action Object (SAO) to XML metadata. For example, IBM's “ViaVoice” takes spoken input and translates it to text. From there, text processing using known art (e.g. “Knowledgist” from Thinking Machines, Corporation) could be used to extract Subject Action Object (SAO). The SAO triplet may be encoded via Resource Description Framework (RDF) standard. Another possible intermediate translation path is a conversion from natural language to a resource description framework (RDF) to XML metadata. Again, each of these translation paths can occur in the client device 12, network proxy 16, or both. Optionally, the network proxy can hold a table of predefined XML metadata terms, wherein the translation from SAO or RDF to XML metadata includes a mapping of the SAO or RDF to an index of the XML metadata table.

Similarly, any service provider 14 with a new service or application can list that service or application on the network and provide 20 metadata describing the service or application. Preferably, the metadata is comprised of terms that are predefined and agreed-upon for the network, which makes subsequent metadata comparisons easier and more likely to provide a match. The comparison could be done in the network or in the client device. Without the use of predefined keywords it is unlikely that a direct match could be made between the user's needs and preferences and service offered by the service providers on the network, due to the fact that the language used to express each may not match. In this case, a similarity algorithm can be used. Alternatively, keywords provided by the service provider or network can be mapped to agreed-upon metadata, which can be accomplished using XML Style Sheet transforms (XSLT).

The metadata of the new service or application can be “pushed” to the network proxy 16, or the network proxy 16 can perform occasional active searches for new services or applications from the service providers 14. In practice, when a new service or application becomes available in the network (e.g. 4G Alternate Network), it is advertised on the (IP) network using XML notation. In particular, the new service or application can be registered with a service framework of the network, wherein the network proxy can simply poll the service framework for any changes or updates that may be of interest to a user of the client device. The service framework is a facilitator that provides a standard, simple way for services or applications to make themselves available and for network proxies to locate the services or applications that may be of interest to their users. It provides an organization or structure that results in a unified and consistent view of services and applications. Services can register themselves with the service framework and de-register themselves when they become unavailable.

In each client device (or in a network proxy for the client) sits an “aggregator” or “feed reader”, herein collectively referred to as “aggregator”. The aggregator can be a standalone software program. The aggregator, which is associated with each client device collects the advertisements and filters them based on the user preferences. The aggregator then compares the metadata from the service provider stored in its memory with the translated metadata of the user's desired services and preferences. The aggregator may look for only an exact match for those cases where the user is constrained to use only predefined and agreed-upon keywords. Otherwise, the aggregator can look for a substantial match between metadata. Alternatively, the aggregator can use an ontology-based operation to identify semantics of a client's desired service or preferences and compare using a semantic similarity measurement.

If the aggregator finds an exact or substantial match between the client metadata and the metadata of the service or application provided by the service provider, the aggregator alerts the user about the match 22 for the new service or application making it available for subscription. For example, any services or applications with a match to a user's desired service or application can be indicated to the user, such as on a display of the client device, wherein the user can select 25 those services or applications that are desired for subscription. Alternatively, the network proxy 16 can automatically subscribe 26 the user (if the user previously set such a preference) for the matched service or application. In either event, the service provider 14 can then provide 24 the matched or chosen service or application to the client device in accordance with existing protocols. An application manager of the client device then controls the installation and updating of applications, as is known in the art.

It is also envisioned that the network proxy can occasionally track any updates to the services or applications accepted (or rejected) by the user.

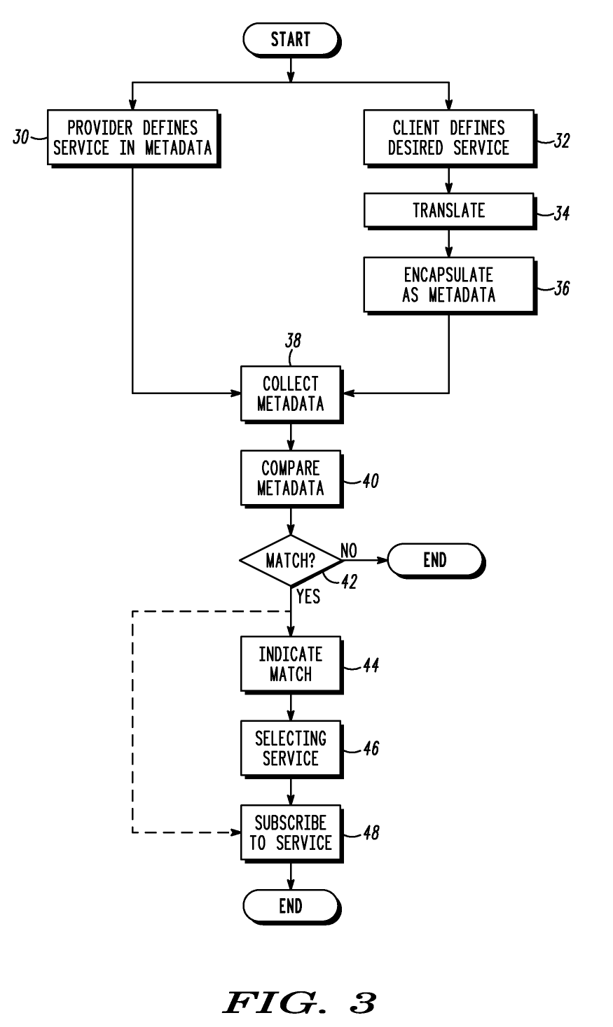

FIG. 3 illustrates a flow diagram of a method of providing a service from an application service provider to a client in a communications system, in accordance with the present invention. In particular, the present invention includes a method for providing a service from an application service provider to a client in a communications system including a communication interface coupling the client and the application service provider. As used herein, “services” refers to either services, applications, and/or preferences.

The method includes a first step 30 of defining services and/or applications provided by the service provider. Preferably, the services are defined as metadata.

In a next step 32, the client defines desired services, applications, and/or preferences. The service can be defined using predefined keywords or natural language.

A next step 34 includes translating the desired services, applications, and/or preferences into Extensible Markup Language (XML) metadata. This step can include translating natural language text into metadata, and the optional intermediate steps of converting from natural language to a Subject Action Object (SAO) to XML metadata, or converting from natural language to a resource description framework (RDF) to XML metadata. The text can be mapped into previously agreed-upon XML metadata or indexed to a table of predefined XML metadata terms. Alternatively, an ontology-based algorithm can be used to identify semantics of the user's text, wherein a subsequent comparison with metadata includes a semantic similarity measurement.

A next step 36 includes encapsulating the services defined by the client in XML metadata.

A next step 38 includes collecting the XML metadata from the client.

A next step 40 includes comparing the client XML metadata against the defined services provided by the service provider. This can be a search for an exact matched where pre-defined keywords are used or a substantial match where only natural language or unassigned keywords are used. Alternatively, an ontology-based semantic similarity measurement can be performed.

A next step 42 includes determining if there is a substantial match of service between the client metadata and the metadata of the defined services provided by the service provider. If there is no match then the process ends.

A next step 44 includes indicating to the client any substantial matches of services.

A next step 46 includes selecting by the client at least one of the indicated substantially matches services.

A next step 48 includes subscribing the client device to the selected service. Alternatively, steps 44 and 46 can be skipped and the subscription from the service provider to the client occurs automatically upon a match and in accordance with the user's preference. As an example, text can be introduced that governs the freedom the user device has in terms of automatically accepting services. This would be via additional constraints introduced that would say, for example, “give me an application that provides function X on object Y, but only during the time window of 12:00 A.M. through 5:00 A.M and only if the cost to me is less than $5.00”, etc. The enabler here could be a much simplified version of a rule scripting language such as JESS or JBoss Rules, as are known in the art. For example, JBoss Rules has a semantic language that would allow this specification of the user's preference(s).

In a preferred embodiment, the communication interface includes a network proxy for the client, wherein the encapsulating, collecting, and comparing steps 36-40 are performed in the network proxy.

### EXAMPLE

In accordance with the present invention, the following presents an envisioned scenario as applied to a wireless Internet connection. A user desires a service that allows them to interrupt, or barge into, existing phone calls of their children, circumventing the problem of their children ignoring the parent's calls when already engaged in a conversation with a friend. The user describes the desired service in a spoken natural language format, using a short code (i.e. *90) to access an interactive voice response system to capture the feature request. The voice response system captures the spoken language and, in concert with the network proxy, converts it into XML metadata. The proxy then searches for a service match with what the carrier currently offers. At this point, the metadata is stored in the proxy since no such service exists. The carrier may used this cached service request to estimate overall demand for a particular service, thus determining costs of the service, likely penetration, profitability, etc. When the carrier desires to offer the service, he brings the server on line, which then informs all proxies of the new service available. The service is described to the proxies using XML metadata. Each proxy now compares the service available with their existing services cache. When a match is found, the user is notified or automatically subscribed to the service.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for providing a service from an application service provider to a client in a communications system including a communication interface coupling the client and the application service provider, the method comprising the steps of:
defining services provided by the service provider;
defining services desired by the client;
encapsulating the services defined by the client in Extensible Markup Language (XML) metadata;
collecting the XML metadata from the client;
comparing the client XML metadata against the defined services provided by the service provider; and
upon the finding of a substantial match of service between the client metadata and the defined services provided by the service provider in the comparing step, providing the substantially matched service from the service provider to the client.

2. The method of claim 1, wherein the step of defining services desired by the client is performed using natural language, and wherein the encapsulating step includes translating the natural language text into XML metadata.

3. The method of claim 1, wherein the communication interface includes a network proxy for the client, and wherein the encapsulating, collecting, and comparing steps are performed in the network proxy.

4. The method of claim 1, wherein the step of defining services provided by the service provider includes defining the provided services as XML metadata.

5. The method of claim 1, wherein the providing step includes the substeps of:
indicating to the client any substantial matches of services;
selecting by the client at least one of the indicated substantially matches services; and
subscribing the client device to the selected service.

6. The method of claim 1, wherein the providing step includes automatically subscribing the client device to a substantially matched service.

7. The method of claim 2, wherein the encapsulating step includes translating the natural language text into one of the group of a subject action object (SAO) and resource description framework (RDF), which is then mapped to an index of XML metadata.

8. The method of claim 1, wherein the step of defining services desired by the client includes defining preferences of the client.

9. The method of claim 1, wherein the defining steps include defining a service using predefined keywords, and the encapsulating step includes mapping the keywords into previously agreed-upon XML metadata.

10. The method of claim 1, wherein the step of defining services desired by the client includes using an ontology-based operation to identify semantics of a client's service, and wherein the comparison step includes comparing using a semantic similarity measurement.

11. A method for providing a service from an Internet service provider to a client in a communications system including a communication interface including a network proxy coupling the client and the Internet service provider, the method comprising the steps of:
defining services provided by the service provider as Extensible Markup Language (XML) metadata;
defining services desired by the client as XML metadata;
collecting the XML metadata from the client and service provider;
comparing the client XML metadata against the service provider XML metadata; and
upon the finding of a substantial match between the client metadata and the service provider metadata in the comparing step, providing the substantially matched service from the service provider to the client.

12. The method of claim 11, wherein the step of defining services desired by the client is performed using natural language, and wherein the encapsulating step includes translating the natural language text into XML metadata.

13. The method of claim 12, wherein the step of defining services desired by the client includes translating the natural language text into a subject action object (SAO), which is then mapped to an index of XML metadata.

14. The method of claim 12, wherein the step of defining services desired by the client includes translating the natural language text into a resource description framework (RDF), which is then mapped to an index of XML metadata.

15. The method of claim 11, wherein the providing step includes the substeps of:
indicating to the client any substantial matches of services;
selecting by the client at least one of the indicated substantially matches services; and
subscribing the client device to the selected service.

16. The method of claim 11, wherein the providing step includes automatically subscribing the client device to a substantially matched service.

17. The method of claim 11, wherein the step of defining services desired by the client includes defining preferences of the client.

18. The method of claim 11, wherein the defining steps include defining a service using predefined keywords, which are then mapped into previously agreed-upon XML metadata.

19. The method of claim 11, wherein the step of defining services desired by the client includes using an ontology-based operation to identify semantics of a client's service, and wherein the comparison step includes comparing using a semantic similarity measurement.

20. A communications system that provides a service from an application service provider to a client in a communications system including a communication interface coupling the client and the application service provider, the system comprising:
a network proxy comprising:
a processor;
a wireless interface coupled to the processor to enable the network proxy to communicate with the client to obtain Extensible Markup Language (XML) defining services desired by the client;
a second interface coupled to the processor to enable the network proxy to communicate with the service provider to obtain XML metadata defining services provided by the service provider; and
a memory coupled to the processor, wherein the memory stores the XML metadata from the client and service provider, and wherein the processor compares the client XML metadata against the service provider XML metadata, and upon the finding of a substantial match between the client metadata and the service provider metadata, the network proxy provides information about the match in order for the service provider to provide the substantially matched service from the service provider to the client.
